(19) United States
(12) Patent Application Publication
(10) Pub. No.: US 2026/0030099 A1
(43) Pub. Date: Jan. 29, 2026

(54) DATA PATH PROTECTION IN MEMORY SYSTEMS

(71) Applicant: Micron Technology, Inc., Boise, ID (US)

(72) Inventors: Kevin Gajera, München (DE); Thomas Hein, München (DE); Casto Salobrena Garcia, München (DE)

(21) Appl. No.: 19/273,959

(22) Filed: Jul. 18, 2025

Related U.S. Application Data
(60) Provisional application No. 63/675,642, filed on Jul. 25, 2024.

(51) Int. Cl. G06F 11/10

(52) U.S. Cl. CPC G06F 11/1044; G06F 11/1004

(57) ABSTRACT

Methods, systems, and devices for data path protection in memory systems are described. A memory system may calculate a data path protection (DPP) parity bit to ensure data transferred between the memory system and a host system is accurate. For example, the memory system may perform, as part of an error correction code (ECC) operation, multiple first logical operations on data bits to generate ECC parity bits. In response to generating the ECC parity bits, the memory system may perform, as part of a data path parity operation, multiple second logical operations on the ECC parity bits to generate an intermediate parity bit, where the memory system may perform a third logical operation between a single error correction bit and the intermediate parity bit to generate a DPP parity bit. In such examples, the memory system may output the DPP parity bit to the host system.

### CROSS REFERENCE

The present application for patent claims the benefit of U.S. Provisional Patent Application No. 63/675,642 by Gajera et al., entitled “DATA PATH PROTECTION IN MEMORY SYSTEMS,” filed Jul. 25, 2024, assigned to the assignee hereof, and expressly incorporated by reference herein.

### TECHNICAL FIELD

The following relates to one or more systems for memory, including data path protection in memory systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports data path protection in memory systems in accordance with examples as disclosed herein.

FIG. 2 shows an example of a system that supports data path protection in memory systems in accordance with examples as disclosed herein.

FIG. 3 shows an example of a system that supports data path protection in memory systems in accordance with examples as disclosed herein.

FIG. 4 shows an example of a data path that supports data path protection in memory systems in accordance with examples as disclosed herein.

FIG. 5 shows a block diagram of a memory system that supports data path protection in memory systems in accordance with examples as disclosed herein.

FIGS. 6 through 8 show flowcharts illustrating a method or methods that support data path protection in memory systems in accordance with examples as disclosed herein.

### DETAILED DESCRIPTION

A memory system may include one or more data paths, which may facilitate a transfer of data between the memory system and a host system. For example, the memory system may implement a read data path that includes one or more components enabling the memory system to transfer data from one or more memory arrays of the memory system to the host system. Similarly, the memory system may implement a write data path that includes one or more components enabling the host system to transfer data to be written into the one or more memory arrays of the memory system. In some cases, to ensure data reliability and security, the memory system may implement a data path protection (DPP) parity operation. For example, in response to a read command, the memory system may read data bits from the memory array, perform error correction code (ECC) operations to correct the data bits, and perform a DPP parity operation on the corrected data bits to obtain a DPP parity bit, where the host system may use the DPP parity bit to determine whether any bit errors occurred in the corrected data bits over the data path. In such cases, however, the DPP parity operation may involve an increased quantity of logical operations (e.g., eight stages of XOR operations for 256 data bits), which may increase latency during access commands and involve an increased quantity of circuit elements, leading to a relatively larger physical area on the device for the DPP parity operation, among other things. Thus, techniques may be desired to reduce latency, reduce the physical area on the device associated with the DPP parity operation, while also maintaining data protection across the data path.

The techniques, methods, and devices described herein may enable the memory system to perform a DPP parity operation using ECC parity bits (e.g., instead of the corrected data) generated during the ECC operations, which may lead to reduced latency, a reduced quantity of logical operations (e.g., four stages of XOR operations), among other advantages. For example, in response to a read command, the memory system may perform, during the ECC operations, multiple first logical operations (e.g., XOR operations) on data bits (e.g., uncorrected data bits) read from the memory array to generate ECC parity bits (e.g., where such ECC parity bits may be generated using an odd-weighted ECC matrix). Accordingly, the memory system may perform multiple second logical operations on the ECC parity bits to generate an intermediate parity bit. Because the intermediate parity bit is based on ECC parity bits generated from the uncorrected data bits, the memory system may perform a third logical operation between the intermediate parity bit and a single error correction (SEC) bit generated during the ECC operations to obtain the DPP parity bit, where the SEC bit indicates whether a single error was corrected during the ECC operations. In this way, if the memory system corrected a single bit error during the ECC operation, the memory system may correct the polarity of the DPP parity bit. Alternatively, if the memory system does not identify and correct a single bit error during the ECC operations, the memory system may pass through the DPP parity bit.

Additionally or alternatively, in response to a write command, the memory system may perform, as part of a write ECC operation, multiple first logical operations on data bits to be written to the memory array to generate ECC parity bits (e.g., using the odd-weighted matrix). Based on generating the ECC parity bits, the memory system may perform multiple second logical operations on the ECC parity bits to obtain a DPP parity bit, where the memory system may perform a third logical operation between the DPP parity bit and a received parity bit to determine whether any bit errors occurred during the transfer of the data bits. By performing the DPP parity operations using the ECC parity bits, the memory system may reduce the quantity of logical operations used to obtain the DPP parity bit, thereby reducing latency, reduce the physical area on the device associated with DPP parity operations, among other advantages. Additionally, by performing the third logical operation between the intermediate parity bit and the SEC bit, the memory system may ensure that the DPP parity bit is accurate, thereby maintaining the protection and security of the data bits over the data path.

In addition to applicability in memory systems as described herein, techniques for DPP in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing the quantity of logical gates and operations performed during DPP parity calculations, which may decrease latency times during access operations, improve response times, or otherwise improve user experience, among other benefits.

Features of the disclosure are illustrated and described in the context of systems and architectures. Features of the disclosure are further illustrated and described in the context of data paths and flowcharts.

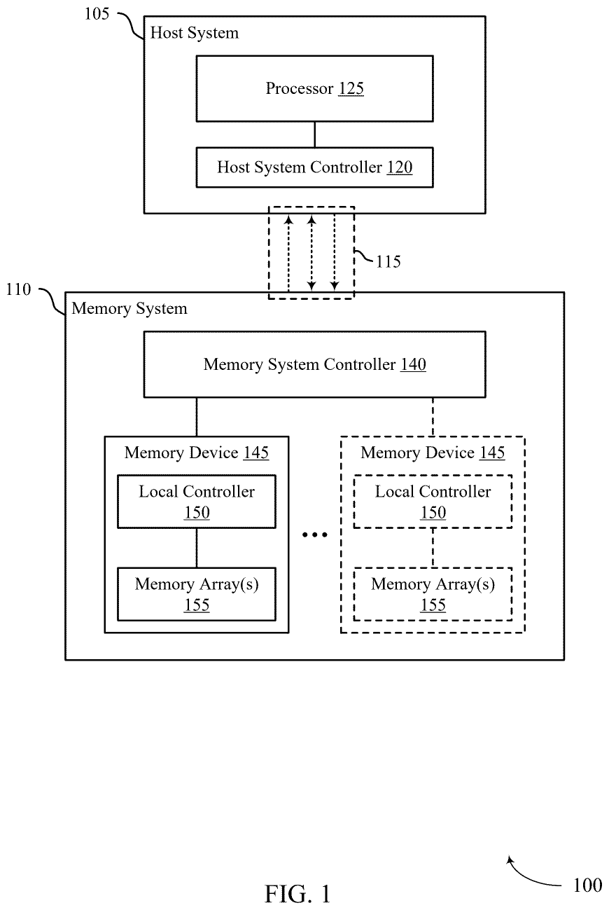

FIG. 1 illustrates an example of a system 100 that supports data path protection in memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105 and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0) and may be an example of an M-ary modulation scheme where M is equal to two. Examples of binary-symbol modulation schemes include non-return-to-zero (NRZ) (e.g., pulse amplitude modulation (PAM) having two symbols (PAM2), unipolar encoding, bipolar encoding, Manchester encoding, and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

The memory system 110 may include one or more data paths, which may facilitate a transfer of data between the memory system 110 and a host system 105 over the channels 115. For example, the memory system 110 may implement a read data path that includes one or more components enabling the memory system 110 to transfer data from a memory array of the memory system 110 to the host system 105 over the channels 115. Similarly, the memory system 110 may implement a write data path that includes one or more components enabling the host system 105 to transfer data to be written into the memory array of the memory system 110 over the channels 115. In some cases, to ensure data reliability and security, the memory system 110 may implement a DPP parity operation. For example, in response to a read command, the memory system 110 may read data bits from the memory array, perform ECC operations to correct the data bits, and perform a DPP parity operation on the corrected data bits to obtain a DPP parity bit. Accordingly, the memory system 110 may output the data bits, the DPP parity bit, or both over the channels 115, where the host system 105 may use the DPP parity bit to determine whether any bit errors occurred in the corrected data bits over the data path. In such cases, however, the DPP parity operation may involve an increased quantity of logical operations (e.g., eight stages of XOR operations for 256 data bits), which may increase latency during access commands and involve an increased quantity of circuit elements, leading to a relatively larger physical area on the device for the DPP parity operation, or both. Thus, techniques may be desired to reduce latency, reduce the physical area on the device associated with the DPP parity operation, while also maintaining data protection across the data path.

The techniques, methods, and devices described herein may enable the memory system 110 to perform the DPP parity operation using ECC parity bits (e.g., instead of the corrected data) generated during the ECC operations, which may lead to reduced latency, a reduced quantity of logical operations (e.g., four stages of XOR operations), or both. For example, in response to a read command, the memory system 110 may perform, during the ECC operations, multiple first logical operations (e.g., XOR operations) on data bits (e.g., uncorrected data bits) read from the memory array to generate ECC parity bits. Accordingly, the memory system 110 may perform multiple second logical operations on the ECC parity bits to generate an intermediate parity bit. Because the intermediate parity bit is based on the ECC parity bits generated from the uncorrected data bits, the memory system 110 may perform a third logical operation between the intermediate parity bit and a SEC bit generated during the ECC operations to obtain the DPP parity bit, where the SEC bit indicates whether a single error was corrected during the ECC operations. In this way, if the memory system 110 corrected a single bit error during the ECC operation, the memory system 110 may correct the polarity of the DPP parity bit. Alternatively, if the memory system 110 does not identify and correct a single bit error during the ECC operations, the memory system 110 may pass through the DPP parity bit.

Similarly, in response to a write command, the memory system 110 may perform, as part of a write ECC operation, multiple first logical operations on data bits to be written to the memory array to generate ECC parity bits. Based on generating the ECC parity bits, the memory system 110 may perform multiple second logical operations on the ECC parity bits to obtain the DPP parity bit, where the memory system 110 may perform a third logical operation between the DPP parity bit and a received parity bit to determine whether any bit errors occurred during the transfer of the data bits. By performing the DPP parity operations using the ECC parity bits, the memory system 110 may reduce the quantity of logical operations used to obtain the DPP parity bit, thereby reducing latency, reduce the physical area on the device associated with DPP parity operations, among other advantages. Additionally, by performing the third logical operation between the intermediate parity bit and the SEC bit, the memory system 110 may ensure that the DPP parity bit is accurate, thereby maintaining the protection and security of the data bits over the data path.

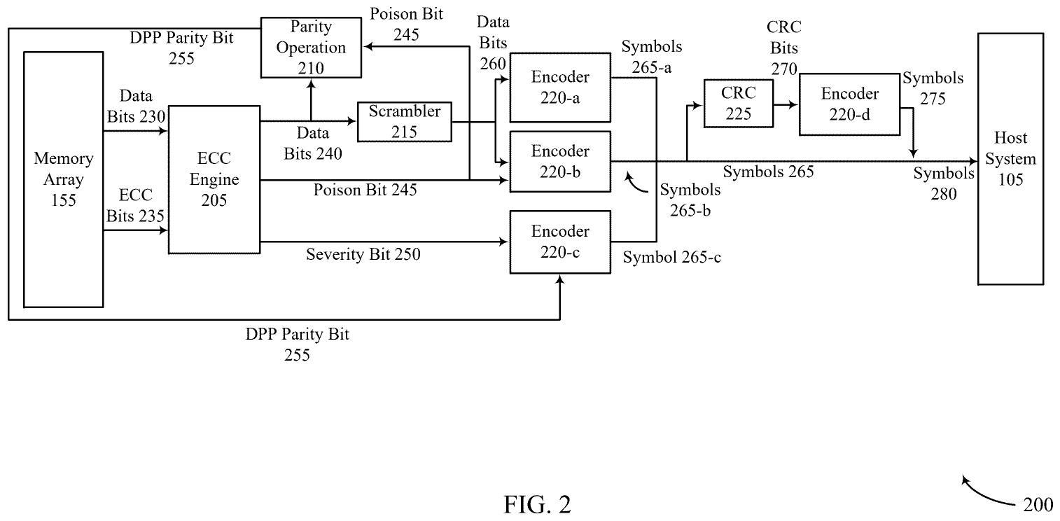

FIG. 2 shows an example of a system 200 that supports data path protection in memory systems in accordance with examples as disclosed herein. Aspects of the system 200 may implement, or be implemented by, aspects of the system 100. For example, the system 200 may include a memory array 155 of a memory system 110 and a host system 105, which may be examples of corresponding devices as described herein with reference to FIG. 1. The system 200 may include circuitry associated with a read data path between the memory array 155 (e.g., core DRAM) and the host system 105, where the circuitry may include an ECC engine 205, a parity operation 210, a scrambler 215, one or more encoders 220, a cyclic check redundancy (CRC) operation 225, or a combination of such components. As described herein, the circuitry associated with the read data path may be included within the memory system 110, the host system 105, an interface between the memory system 110 and the host system 105, or a combination thereof.

In some examples, the memory system 110 may have different error correction and detection features for end-to-end secure data transmission during read operations from the memory array 155 to the host system 105. In such examples, the memory system 110 may implement the ECC engine 205 to correct data bits 230 obtained from the memory array 155, while the memory system 110 may protect the data bits 230 over the read data path (e.g., scrambler 215, encoders 220, or both) according to a DPP parity bit 255. Similarly, the memory system 110 may utilize the CRC operation 225 to protect the data bits 230 at the interface between the memory system 110 and the host system 105.

For example, in response to a read command from the host system 105, the memory system 110 may obtain the data bits 230 and associated ECC bits 235 (e.g., parity bits, poison bits, among other examples) from the memory array 155 and input the data bits 230 and ECC bits 235 into the ECC engine 205. The ECC engine 205 may correct the data bits 230 using the ECC bits 235 and generate data bits 240 (e.g., corrected data), a poison bit 245 (e.g., indicating whether the data is correct), a severity bit 250 (e.g., indicating whether an uncorrected error has occurred in the data bits 230), or a combination thereof. Based on generating the data bits 240, the scrambler 215 may receive the data bits 240 and perform a bitwise XOR operation on the data bits 240 to generate the data bits 260 using a scrambler code that may be programmed in a mode register of the memory system 110. In such examples, the scrambler 215 may generate the data bits 260 prior to encoding of the data bits 260 by the encoders 220 (e.g., for PAM3 signaling).

In some cases, the memory system 110 may perform a parity operation 210 using the data bits 240 (e.g., the corrected data or data output from the ECC engine 205), the poison bit 245, or both to generate the DPP parity bit 255. In such examples, the parity operation 210 may involve performing multiple logical operations using the data bits 240 to generate the DPP parity bit 255. As an illustrative example, the data bits 240 may include 256 bits, and, as such, the memory system 110 may, perform eight stages XOR operations to obtain the DPP parity bit 255.

In response to generating DPP parity bit 255 and the data bits 260, the memory system 110 may perform encoding, where the memory system 110 may generate the symbols 265 based on the data bits 260, the poison bit 245, the severity bit 250, the DPP parity bit 255, or a combination thereof. For example, the encoder 220-a may receive a first subset of the data bits 260 (e.g., 253 bits of 256 bits) and encode the first subset of the data bits 260 to generate the symbols 265-a (e.g., 161 symbols), while the encoder 220-b may receive a second subset of the data bits 260 (e.g., 3 bits of the 256 bits) and the poison bit 245 and encode the second subset of the data bits 260 and the poison bit to generate the symbols 265-b (e.g., 2 symbols). In such examples, the encoder 220-a may be referred to as an eleven-bits-to-seven-symbols (11b7S) encoder, while the encoder 220-b may be referred to as a three-bits-to-two-symbols (3b2S) encoder. Similarly, the encoder 220-c may receive the DPP parity bit 255 and the severity bit 250 and encode the DPP parity bit 255 and the severity bit 250 to generate the symbol 265-c (e.g., one symbol, encoded DPP parity bit 255). In such examples, the encoder 220-c may be referred to as two-bits-to-1-symbol (2b1S) encoder.

The memory system 110 may combine the symbols 265-a, 265-b, and 265-c into the symbols 265 (e.g., 164 symbols), where the memory system 110 may proceed to perform a CRC operation 225 on the symbols 265 to generate the CRC bits 270 (e.g., 18 bits). Based on generating the CRC bits 270, the memory system 110 may encode the CRC bits 270 into the symbols 275 (e.g., CRC symbols, 12 symbols) using the encoder 220-d, where the encoder 220-d may be referred to as a 3b2S encoder. Based on generating the symbols 275, the memory system 110 may combine (e.g., append) the symbols 265 with the symbols 275 to generate the symbols 280 (e.g., 176 symbols) and output the symbols 280 to the host system 105 via the channels 115. Accordingly, the host system 105 may utilize the symbols 275 of the symbols 280 to determine whether any errors occurred in the data at the interface between the host system 105 and the memory system 110. Similarly, upon decoding the symbols to obtain the data bits 240, the host system 105 may calculate a parity bit using the decoded data bits 240 and compare the calculated parity bit with the decoded DPP parity bit 255 to determine whether any errors occurred in the data bits 240 over the read data path. In this way, the memory system 110 and host system 105 may utilize the DPP parity bit 255 to protect the data transmitted over the read path.

In such examples, however, the parity operation 210 may involve an increased quantity of logical operations (e.g., eight stages of XOR operations for 256 data bits), which may increase latency during access commands and involve an increased quantity of circuit elements, leading to a relatively larger physical area on the device for the DPP parity operation, or both. For example, due to the memory system 110 performing the parity operation 210 on all 256 bits of data, the memory system 110 may experience increased latency due to the quantity of logical operations performed. Additionally, such increased quantity of logical operations may involve an increased quantity of logical gates, thereby consuming a relatively larger space on the memory system 110, which may increase cost, among other disadvantages. Thus, techniques may be desired to reduce latency, reduce the physical area on the device associated with the parity operation 210, while also maintaining data protection across the data path.

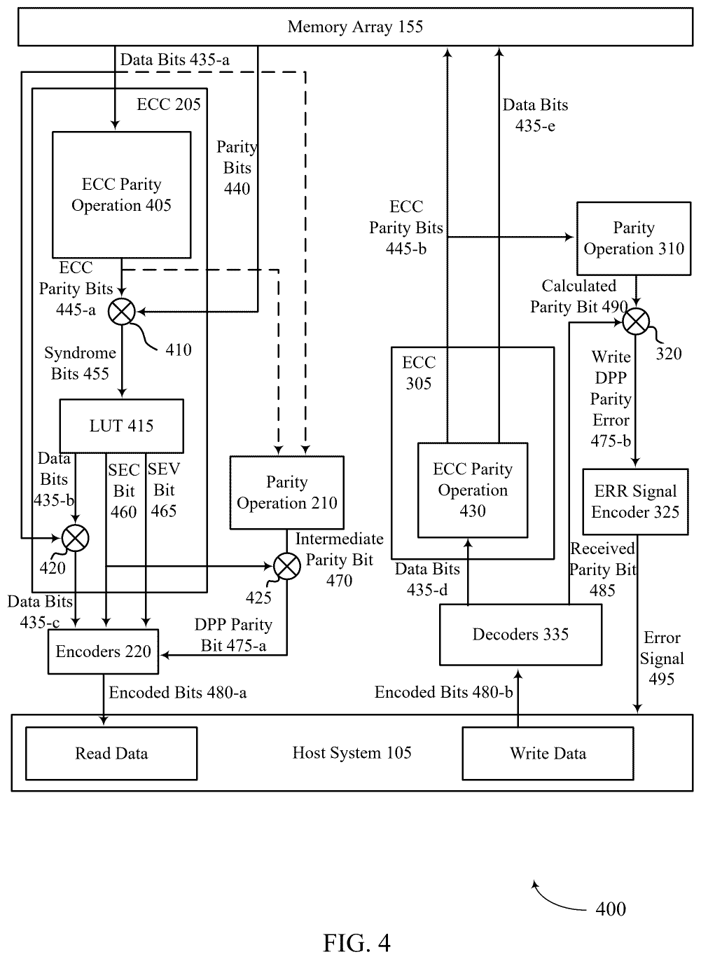

The techniques, methods, and devices described herein may enable the memory system 110 to perform the parity operation 210 using ECC parity bits (e.g., instead of the data bits 240) generated by the ECC engine 205, which may lead to reduced latency, a reduced quantity of logical operations (e.g., four stages of XOR operations), or both. For example, in response to a read command, the ECC engine 205 may perform multiple first logical operations (e.g., XOR operations) on data bits 230 (e.g., uncorrected data bits) read from the memory array 155 to generate ECC parity bits (not shown). Accordingly, as part of the parity operation 210, the memory system 110 may perform multiple second logical operations on the ECC parity bits to generate an intermediate parity bit. Because the intermediate parity bit is generated based on the ECC parity bits (and not the corrected data bits 240), the memory system 110 may perform a third logical operation between the intermediate parity bit and a SEC bit generated by the ECC engine 205 to obtain the DPP parity bit 255, where the SEC bit indicates whether a single error was corrected in the data bits 230. In this way, if the memory system 110 corrected a single bit error in the data bits 230, the memory system 110 may correct the polarity of the DPP parity bit 255. Alternatively, if the memory system 110 does not identify and correct a single bit error in the data bits 230, the memory system 110 may pass through the DPP parity bit 255 to the encoder 220-c. Techniques to generate the DPP parity bit 255 may be further described herein with reference to FIG. 4.

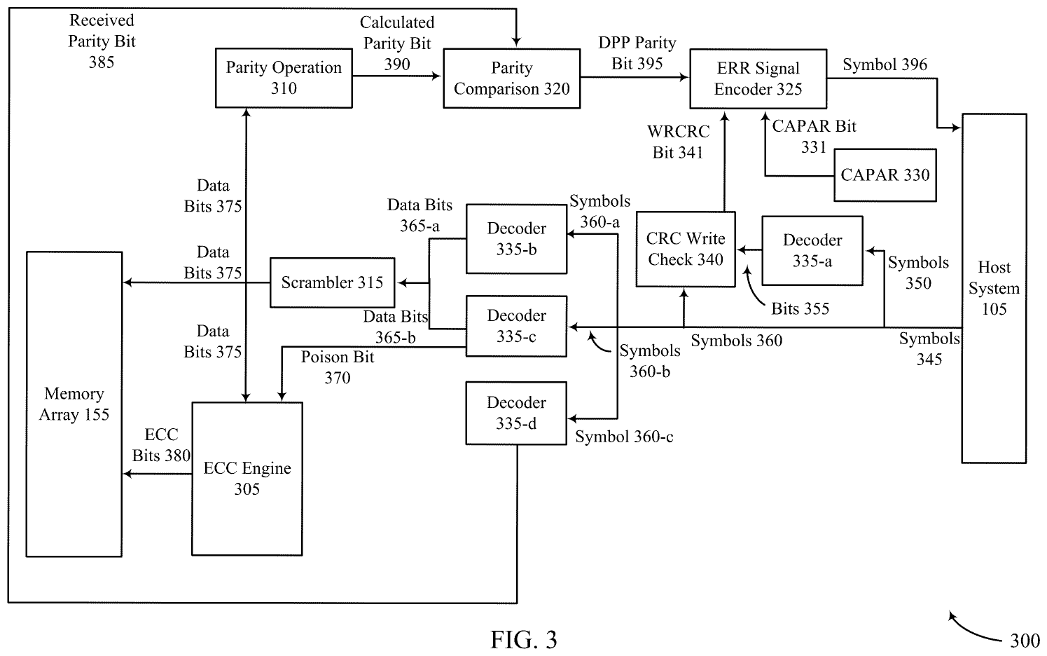

FIG. 3 shows an example of a system 300 that supports data path protection in memory systems in accordance with examples as disclosed herein. Aspects of the system 300 may implement, or be implemented by, aspects of the system 100, the system 200, or both. For example, the system 300 may include a memory array 155 of a memory system 110 and a host system 105, which may be examples of corresponding devices as described herein with reference to FIGS. 1 and 2. The system 300 may include circuitry associated with a write data path between the memory array 155 (e.g., core DRAM) and the host system 105, where the circuitry may include an ECC engine 305, a parity operation 310, a scrambler 315, a parity comparison component 320, an ERR signal encoder 325, a command address parity (CAPAR) component 330, one or more decoders 335, a CRC operation 340, or a combination of such components. As described herein, the circuitry associated with the write data path may be included within the memory system 110, the host system 105, an interface between the memory system 110 and the host system 105, or a combination thereof.

In some examples, the memory system 110 may have different error correction and detection features for end-to-end secure data transmission during read operations from the memory array 155 to the host system 105. In such examples, the memory system 110 may implement the ECC engine 305 to protect data bits 375 being written to the memory array 155, while the memory system 110 may protect the data bits 375 over the write data path (e.g., scrambler 315, decoders 335, or both) according to a DPP parity bit 395. Similarly, the memory system 110 may utilize the CRC operation 340 to protect the data bits 375 at the interface between the memory system 110 and the host system 105.

For example, in response to a write command, the host system 105 may transmit symbols 280 (e.g., 176 symbols) to the memory system 110 over the channels 115. In such examples, the symbols 345 may include the symbols 350 (e.g., 12 symbols or CRC symbols) and symbols 360 (e.g., 164 symbols or data and ECC symbols). Accordingly, the decoder 335-a may receive the symbols 350 and decode the symbols 350 to generate the bits 355 (e.g., CRC bits), where the decoder 335-a may be referred to as a 3b2S decoder. Based on generating the bits 355, the memory system 110 may perform the CRC operation 340 using the bits 355 and the symbols 360 to determine whether the symbols 360 (e.g., encoded data) contain any errors introduced at the interface between the memory system 110 and the host system 105 (e.g., introduced over the channels 115, receivers, transmitters, among other circuitry). For example, the memory system 110 may perform the CRC operation 340 on the symbols 360 to generate CRC bits and may compare the generated CRC bits to the bits 355 to determine whether any errors have occurred in the symbols 360 (e.g., encoded data) and may output the write CRC bit 341 (WRCRC bit) to the ERR signal encoder 325 indicating whether the symbols 360 include any errors. Similarly, the memory system 110 may perform, using the CAPAR component 330, a CAPAR operation to determine whether any parity errors occurred in the command address and may output the CAPAR bit 331 to the ERR signal encoder 325 indicating whether any parity errors occurred in the command address.

In response to, or in conjunction with, performing the CAPAR operation and the CRC operation 340, the memory system 110 may decode the symbols 360 (e.g., PAM3 decoding) to obtain the data bits 365-a, the data bits 365-b, and the poison bit 370. For example, the decoder 335-b may receive the symbols 360-a (e.g., 161 of the 164 symbols) and decode the symbols 360-a to obtain the data bits 365-a (e.g., 253 of the 256 bits), where the decoder 335-b may be referred to as a 11b7S decoder. Similarly, the decoder 335-c may receive the symbols 360-b (e.g., 2 of the 164 symbols) and decode the symbols 360-b to obtain the data bits 365-b (e.g., 3 of the 256 bits) and the poison bit 370, where the decoder 335-c may be referred to as 3b2S decoder. Likewise, the decoder 335-d may receive the symbol 360-c (e.g., encoded parity bit or 1 symbol of the 164 symbols) and decode the symbol 360-c to obtain the received parity bit 385.

The scrambler 315 may receive the data bits 365 and descramble the data bits 365 to obtain the data bits 375. For example, the scrambler 315 may perform a bitwise XOR operation on the data bits 365 in response to the decoding and prior to writing the data bits 375 to the memory array 155. The ECC engine 305 may receive the data bits 375, the poison bit 370, or both, and generate the ECC bits 380 (e.g., ECC parity bits poison bit), where the memory system 110 may write the data bits 375, along with the ECC bits 380, to the memory array 155.

Additionally, based on performing the scrambling, the memory system 110 may perform the parity operation 310 to generate the calculated parity bit 390. In such examples, the memory system 110 may perform multiple logical operations on the data bits 375 to obtain the calculated parity bit 390. As an illustrative example, if the data bits 375 include 256 bits, the memory system 110 may perform 8 stages of XOR operations during the parity operation 310 to obtain the calculated parity bit 390.

The memory system 110 may proceed to perform, using the parity comparison component 320, a comparison between the received parity bit 385 (e.g., received from the host system 105) and the calculated parity bit 390 to determine whether any errors (e.g., odd quantity of errors) have occurred in the data bits 375 over the write data path. For example, the memory system 110 may XOR the calculated parity bit 390 with the received parity bit 385 to generate the DPP parity bit 395, indicating whether any errors have occurred in the data bits 375 over the write data path. The ERR signal encoder 325 may receive the DPP parity bit 395, the WRCRC bit 341, the CAPAR bit 331 and output the symbol 396 indicating whether an error has occurred in the command address, in the symbols 360, or in the data bits 375.

In such examples, however, the parity operation 310 may involve an increased quantity of logical operations (e.g., eight stages of XOR operations for 256 data bits), which may increase latency during access commands and involve an increased quantity of circuit elements, leading to a relatively larger physical area on the device for the DPP parity operation, or both. For example, due to the memory system 110 performing the parity operation 310 on all 256 bits of data, the memory system 110 may experience increased latency due to the quantity of logical operations performed. Additionally, such increased quantity of logical operations may involve an increased quantity of logical gates, thereby consuming a relatively larger space on the memory system 110, which may increase cost, among other disadvantages. Thus, techniques may be desired to reduce latency, reduce the physical area on the device associated with the parity operation 310, while also maintaining data protection across the data path.

The techniques, methods, and devices described herein may enable the memory system 110 to perform the parity operation 310 using ECC parity bits (e.g., instead of the data bits 375) generated by the ECC engine 305, which may lead to reduced latency, a reduced quantity of logical operations (e.g., four stages of XOR operations), or both. For example, the ECC engine 305 may perform multiple first logical operations on the data bits 375 to generate ECC parity bits (not shown). Based on generating the ECC parity bits, the memory system 110 may perform, as part of the parity operation 310, multiple second logical operations on the ECC parity bits to obtain the calculated parity bit 390, where the memory system 110 may perform a third logical operation between the calculated parity bit 390 and the received parity bit to generate the DPP parity bit 395, which may indicate whether any errors have occurred in the data bits 375 over the write data path. Techniques to generate the DPP parity bit 395 may be further described herein with reference to FIG. 4.

FIG. 4 shows an example of a data path 400 that supports data path protection in memory systems in accordance with examples as disclosed herein. Aspects of the data path 400 may implement, or be implemented by, aspects of the system 100, the system 200, the system 300, or a combination thereof. For example, the data path 400 may be implemented between a memory array 155 of a memory system 110 and a host system 105, which may be examples of corresponding devices as described herein with reference to FIGS. 1-3. The data path 400 may include one or more components associated with a read data path, such as a ECC engine 205, a parity operation 210, and one or more encoders 220, which may be examples of corresponding devices as described herein with reference to FIG. 2. Additionally, the data path 400 may include one or more components associated with a write data path, such as a ECC engine 305, a parity operation 310, an ERR signal encoder 325, and one or more decoders 335, which may be examples of corresponding devices as described herein with reference to FIG. 3. The techniques described in the context of the data path 400 may enable the memory system 110 to perform the parity operations 210 and 310 with reduced latency, with a reduced quantity of logical gates, or both.

In some examples, in response to a read command from the host system 105, the memory system 110 may read data bits 435-a (e.g., 256 bits) and parity bits 440 (e.g., 16 parity bits) from the memory array 155. Based on reading the data bits 435-a, the ECC engine 205 may perform, as part of an ECC parity operation 405, multiple first logical operations on the data bits 435-a to generate ECC parity bits 445-a (e.g., 16 ECC parity bits). For example, the ECC parity operation 405 may be performed using HSIAO codes, which may be a class of linear block codes used to detect and correct multiple errors. As part of the HSIAO code, each bit of the data bits 435-a may be XORed an odd quantity of times and be distributed among all of the ECC parity bits 445-a (e.g., one data bit 435-a may be utilized to generate multiple ECC parity bits 445-a). As an illustrative example, as part of the HSIAO code based ECC parity operation 405, the memory system 110 may XOR each data bit three times to generate the ECC parity bits 445-a. In some examples, the memory system 110 may, as part of the ECC parity operation 405, utilize a HSIAO matrix (e.g., odd-weighted matrix) to generate the ECC parity bits 445-a from the data bits 435-a.

Based on generating the ECC parity bits 445-a, the ECC engine 205 may perform one or more logical operations (e.g., XOR operations 410) between the parity bits 440 and the ECC parity bits 445-a to generate the syndrome bits 455, where the ECC engine 205 may input the syndrome bits 455 into the LUT 415 to determine whether one or more errors have occurred in the data bits 435-a. The ECC engine 205 may utilize the output of the LUT 415 (e.g., an error code) to correct a single error in the data bits 435-a and generate the SEC bit 460, generate the SEV bit 465 indicating that the data bits 435-a include one or more uncorrectable errors, or indicate that the data bits 435-a do not include any errors. For example, the ECC engine may output the data bits 435-c (e.g., corrected data bits), the SEC bit 460, the SEV bit 465, or a combination thereof to the encoders 220, where the encoders 220 may encode the data bits 435-c, the SEC bit 460, the SEV bit 465, or a combination thereof to generate the encoded bits 480-a and transmit the encoded bits 480-a to the host system 105. In some examples, prior to outputting the data bits 435-c, the LUT 415 of the ECC engine 205 may output data bits 435-b and perform an XOR operation 420 between the data bits 435-b and the data bits 435-a to obtain the data bits 435-c (e.g., the corrected data bits).

In accordance with the techniques described herein and to protect the data bits 435-c over the data path, the memory system 110 may calculate a DPP parity bit 475-a, which may be used by the host system 105 to determine whether one or more bit errors (e.g., an odd quantity of bit errors) have occurred in the data bits 435-c over the read data path. In one example, the memory system 110 may, as part of the parity operation 210, perform multiple second logical operations on the ECC parity bits 445-a to generate an intermediate parity bit 470, where a quantity of the second logical operations may be reduced, thereby reducing latency and reducing the quantity of logical gates at the memory system 110. For example, because the ECC parity bits 445-a (e.g., 16 parity bits) are based on performing multiple logical operations on each bit of the data bits 435-a (e.g., being XORed three times each), the memory system 110 may utilize the ECC parity bits 445-a instead of the data bits 435-c for the parity operation 210, thereby reducing the quantity of logical operations performed. Alternatively, in some examples, the memory system 110 may perform, as part of the parity operation 210, multiple second logical operations on the uncorrected data bits 435-a (e.g., using an 8 stage XOR operation) to generate the intermediate parity bit 470. By doing so, the memory system 110 may reduce latency by enabling the memory system 110 to perform the parity operation 210 in parallel (e.g., concurrently) with the ECC operations at the ECC engine 205.

In such examples, because the parity operation 210 is performed on ECC parity bits 445-a calculated from uncorrected data (e.g., the data bits 435-a) or from the uncorrected data bits 435-a, the memory system 110 may perform a third logical operation (e.g., XOR operation 425) between the intermediate parity bit 470 and the SEC bit 460 to generate the DPP parity bit 475-a. For example, if the SEC bit 460 is high (e.g., equal to ‘1’), the memory system 110 may determine that a single data bit of the data bits 435-a has been corrected. Accordingly, the intermediate parity bit 470 may be inaccurate. As such, by performing the XOR operation between the intermediate parity bit 470 and the SEC bit 460, the DPP parity bit 475-a may be accurate (e.g., inverted intermediate parity bit 470).

That is, if there is a single error in the data bits 435-a, then a single bit may be flipped in the data bits 435-a. Accordingly, if the memory system calculates the intermediate parity bit 470 using the ECC parity bits 445-a generated from the incorrect data bits 435-a or from the data bits 435-a themselves, the intermediate parity bit 470 may be inverted as compared to the DPP parity bit calculated using the data bits 435-c (e.g., corrected 256 data bits). As such, to obtain the accurate DPP parity bit 475-a, the memory system 110 may XOR the intermediate parity bit 470 with the SEC bit 460, thereby inverting the intermediate parity bit 470 if the SEC bit 460 is high, indicating a single error correction, or maintaining the intermediate parity bit 470, indicating a single error correction was not performed in the data thereby making the intermediate parity bit 470 accurate.

The encoders 220 may receive the DPP parity bit 475-a and determine whether to encode and transmit the DPP parity bit 475-a to the host system 105. In such examples, the SEV bit 465 may indicate whether an uncorrected error (e.g., multiple bit errors) have occurred in the data bits 435-a. Accordingly, the SEV bit 465 may have a higher priority than that of the DPP parity bit 475-a. For example, if the SEV bit 465 indicates that an uncorrected error has occurred in the data bits 435-a, the memory system 110 may determine that the DPP parity bit 475-a is inaccurate and determine to refrain from encoding and transmitting the DPP parity bit 475-a to the host system 105. Alternatively, if the SEV bit 465 indicates that an uncorrected error has not occurred in the data bits 435-a, the memory system 110 may determine to encode and transmit the DPP parity bit 475-a to the host system 105, where the host system 105 may utilize the DPP parity bit 475-a to determine whether one or more bit-errors (e.g., odd quantity of bit errors) have occurred in the data bits 435. In this way, the memory system 110 may generate the DPP parity bit 475-a, thereby protecting the data bits 435 over the read data path, while also reducing latency, reducing the quantity of logical gates, or both.

In some examples, in response to a write command, the host system 105 may transmit encoded bits 480-b (e.g., 328 bits) to the memory system 110, where the memory system 110 may utilize the decoders 335 to decode the encoded bits 480-b (e.g., symbols) and obtain the data bits 435-d (e.g., 256 bits), the received parity bit 485, and one or more CRC bits (e.g., not shown, and which may be used to determine whether the data bits 435-d include any errors introduced at the interface between the memory system 110 and the host system 105). Based on obtaining the data bits 435-d and the received parity bit 485, the ECC engine 305 may perform an ECC parity operation 430 (e.g., using HSIAO codes, among other examples), which may be similar to the ECC parity operation 405. The ECC engine 305 may, as part of the ECC parity operation 430, generate the ECC parity bits 445-b (e.g., 16 ECC parity bits) and data bits 435-e (e.g., corrected data or 256 corrected data bits).

In accordance with the techniques described herein, instead of performing the parity operation 310 utilizing the data bits 435-e (e.g., corrected data bits), the memory system 110 may, as part of the parity operation 310, perform multiple second logical operations (e.g., four stages of XOR operations) to generate the calculated parity bit 490. By doing so, the memory system 110 may reduce latency associated with generating the calculated parity bit 490, while also reducing the quantity of logical gates used for the parity operation 310. For example, because the ECC parity bits 445-b are reduced in quantity relative to the data bits 435-e, the memory system 110 may utilize a decreased quantity of logical gates (e.g., XOR gates) for the parity operation 310, thereby reducing latency and physical area on the memory system 110.

Accordingly, in response to generating the calculated parity bit 490, the memory system 110 may perform a third logical operation (e.g., XOR) between the calculated parity bit 490 and the received parity bit 485 to obtain the write DPP parity error 475-b (e.g., write DPP parity bit), where the write DPP parity error 475-b may indicate whether an odd quantity of errors (e.g., 1, 3, 5, etc.) errors have occurred in the data bits 435-e over the write data path. As such, the ERR signal encoder 325 may obtain the write DPP parity error 475-b and determine whether to output the error signal 495. In some examples, the ERR signal encoder 325 may output the error signal if the write DPP parity error 475-b indicates that an error has occurred in the data bits 435-c. In this way, the memory system 110 may generate and utilize the write DPP parity error 475-b to protect the data bits 435 over the write data path, while also reducing latency during the write operation.

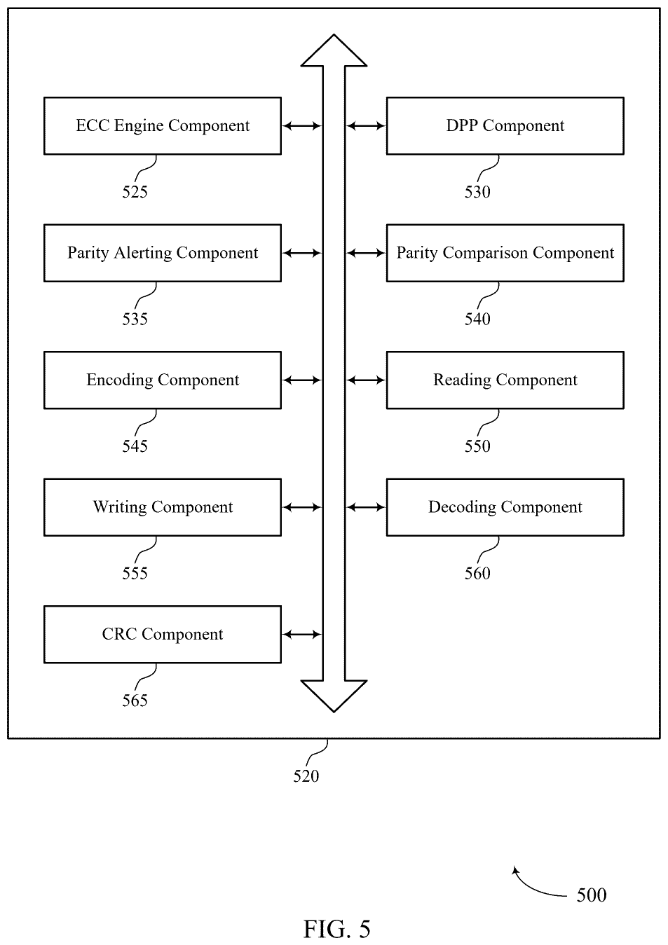

FIG. 5 shows a block diagram 500 of a memory system 520 that supports data path protection in memory systems in accordance with examples as disclosed herein. The memory system 520 may be an example of aspects of a memory system as described with reference to FIGS. 1 through 4. The memory system 520, or various components thereof, may be an example of means for performing various aspects of data path protection in memory systems as described herein. For example, the memory system 520 may include a ECC engine component 525, a DPP component 530, a parity alerting component 535, a parity comparison component 540, an encoding component 545, a reading component 550, a writing component 555, a decoding component 560, an CRC component 565, or any combination thereof. Each of these components, or components of subcomponents thereof (e.g., one or more processors, one or more memories), may communicate, directly or indirectly, with one another (e.g., via one or more buses).

The memory system 520 may support operating a memory system in accordance with examples as disclosed herein. The ECC engine component 525 may be configured as or otherwise support a means for performing, as part of an ECC operation at the memory system, a plurality of first logical operations on a plurality of data bits to generate a plurality of ECC parity bits. The DPP component 530 may be configured as or otherwise support a means for performing, based at least in part on generating the plurality of ECC parity bits and as part of a data path parity operation at the memory system, a plurality of second logical operations on the plurality of ECC parity bits to generate an intermediate parity bit. In some examples, the DPP component 530 may be configured as or otherwise support a means for performing, as part of the data path parity operation, a third logical operation between a single error correction bit and the intermediate parity bit to generate a data path parity bit. The parity alerting component 535 may be configured as or otherwise support a means for outputting the data path parity bit to a host system coupled with the memory system.

In some examples, the encoding component 545 may be configured as or otherwise support a means for encoding, based at least in part on performing the third logical operation, the data path parity bit, where outputting the data path parity bit to the host system is based at least in part on encoding the data path parity bit.

In some examples, the encoding component 545 may be configured as or otherwise support a means for determining whether to encode the data path parity bit based at least in part on a value of a severity bit generated as part of the ECC operation on the plurality of data bits, the value of the severity bit indicating whether the plurality of data bits include an uncorrected error, where encoding the data path parity bit is based at least in part on the value of the severity bit indicating that the plurality of data bits do not include the uncorrected error.

In some examples, a priority associated with the severity bit is greater than a priority associated with the data path parity bit. In some examples, encoding the data path parity bit is further based at least in part on the priority associated with the severity bit being greater than the priority of the data path parity bit.

In some examples, the uncorrected error includes one or more bits of the plurality of data bits being corrupted and uncorrectable.

In some examples, the reading component 550 may be configured as or otherwise support a means for obtaining the plurality of data bits from a memory array of the memory system based at least in part on receiving a read request from the host system, where generating the plurality of ECC parity bits is based at least in part on obtaining the plurality of data bits from the memory array.

In some examples, the ECC engine component 525 may be configured as or otherwise support a means for performing a fourth logic operation between the plurality of ECC parity bits and a plurality of parity bits stored with the plurality of data bits to generate a plurality of syndrome bits. In some examples, the ECC engine component 525 may be configured as or otherwise support a means for determining whether one or more bit-errors have occurred in the plurality of data bits based at least in part on an error code generated from the plurality of syndrome bits, where a value of the single error correction bit is based at least in part on determining whether the one or more bit-errors have occurred in the plurality of data bits.

In some examples, the plurality of first logical operations include a plurality of first XOR operations, the plurality of second logical operations include a plurality of second XOR operations, and the third logical operation is an XOR operation.

Additionally, or alternatively, the memory system 520 may support operating a memory system in accordance with examples as disclosed herein. In some examples, the ECC engine component 525 may be configured as or otherwise support a means for performing, as part of an ECC operation, a plurality of first logical operations on a plurality of data bits to generate a plurality of ECC parity bits. In some examples, the DPP component 530 may be configured as or otherwise support a means for performing, based at least in part on generating the plurality of ECC parity bits and as part of a data path parity operation, a plurality of second logical operations on the plurality of ECC parity bits to generate a data path parity bit. The parity comparison component 540 may be configured as or otherwise support a means for performing, as part of the data path parity operation, a third logical operation between a received parity bit and the calculated parity bit to generate a write data path parity error. In some examples, the parity alerting component 535 may be configured as or otherwise support a means for outputting the write data path parity error to a host system coupled with the memory system.

In some examples, the writing component 555 may be configured as or otherwise support a means for receiving, from the host system, a write request that includes a plurality of encoded bits. In some examples, the decoding component 560 may be configured as or otherwise support a means for decoding the plurality of encoded bits to obtain the plurality of data bits based at least in part on receiving the write request, where generating the plurality of ECC parity bits is based at least in part on decoding the plurality of encoded bits.

In some examples, the CRC component 565 may be configured as or otherwise support a means for receiving, as part of the write request, a plurality of CRC bits associated with the plurality of encoded bits. In some examples, the CRC component 565 may be configured as or otherwise support a means for detecting, based at least in part on decoding the plurality of encoded bits, whether one or more bit-errors are included in the plurality of data bits using the plurality of CRC bits, where performing the plurality of first logical operations is based at least in part on detecting whether the one or more bit-errors.

In some examples, the received parity bit is obtained based at least in part on decoding the plurality of encoded bits. In some examples, performing the third logical operation is based at least in part on decoding the plurality of encoded bits.

In some examples, the write data path parity error indicates whether an odd quantity of uncorrected errors are present in the plurality of data bits.

In some examples, the plurality of first logical operations include a plurality of first XOR operations, the plurality of second logical operations include a plurality of second XOR operations, and the third logical operation is an XOR operation.

Additionally, or alternatively, the memory system 520 may support operating a memory system in accordance with examples as disclosed herein. In some examples, the DPP component 530 may be configured as or otherwise support a means for performing, as part of a DPP parity operation at the memory system, a plurality of first logical operations on a plurality of data bits to generate an intermediate parity bit. In some examples, the DPP component 530 may be configured as or otherwise support a means for performing, as part of the data path parity operation, a second logical operation between a single error correction bit and the intermediate parity bit to generate a data path parity bit. In some examples, the parity alerting component 535 may be configured as or otherwise support a means for outputting the data path parity bit to a host system coupled with the memory system.

In some examples, the encoding component 545 may be configured as or otherwise support a means for encoding, based at least in part on performing the second logical operation, the data path parity bit, where outputting the data path parity bit to the host system is based at least in part on encoding the data path parity bit.

In some examples, the encoding component 545 may be configured as or otherwise support a means for determining whether to encode the data path parity bit based at least in part on a value of a severity bit generated as part of an ECC operation on the plurality of data bits, the value of the severity bit indicating whether the plurality of data bits include an uncorrected error, where encoding the data path parity bit is based at least in part on the value of the severity bit indicating that the plurality of data bits do not include the uncorrected error.

In some examples, a priority associated with the severity bit is greater than a priority associated with the data path parity bit. In some examples, encoding the data path parity bit is further based at least in part on the priority associated with the severity bit being greater than the priority of the data path parity bit.

In some examples, the uncorrected error includes one or more bits of the plurality of data bits being corrupted and uncorrectable.

In some examples, the reading component 550 may be configured as or otherwise support a means for obtaining the plurality of data bits from a memory array of the memory system based at least in part on receiving a read request from the host system, where performing the plurality of first logical operations is based at least in part on obtaining the plurality of data bits from the memory array.

In some examples, the plurality of first logical operations include a plurality of first XOR operations, and the second logical operation is an XOR operation.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

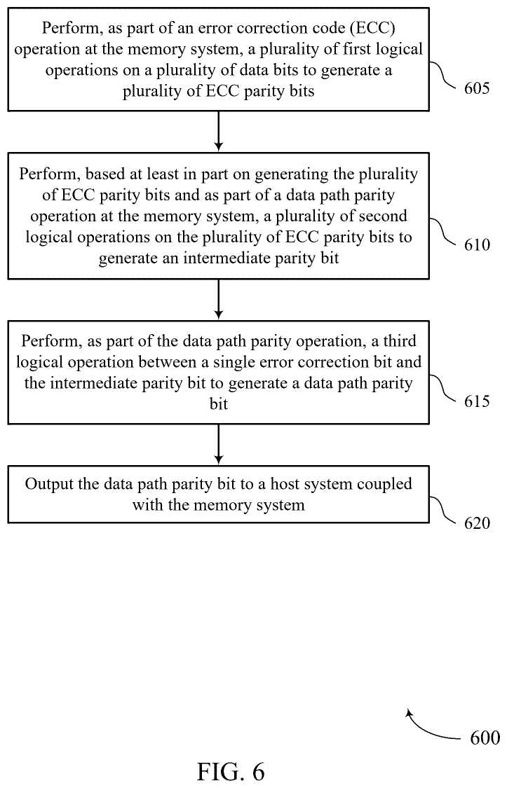

FIG. 6 shows a flowchart illustrating a method 600 that supports data path protection in memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include performing, as part of an ECC operation at the memory system, a plurality of first logical operations on a plurality of data bits to generate a plurality of ECC parity bits. In some examples, aspects of the operations of 605 may be performed by a ECC engine component 525 as described with reference to FIG. 5.

At 610, the method may include performing, based at least in part on generating the plurality of ECC parity bits and as part of a data path parity operation at the memory system, a plurality of second logical operations on the plurality of ECC parity bits to generate an intermediate parity bit. In some examples, aspects of the operations of 610 may be performed by a DPP component 530 as described with reference to FIG. 5.

At 615, the method may include performing, as part of the data path parity operation, a third logical operation between a single error correction bit and the intermediate parity bit to generate a data path parity bit. In some examples, aspects of the operations of 615 may be performed by a DPP component 530 as described with reference to FIG. 5.

At 620, the method may include outputting the data path parity bit to a host system coupled with the memory system. In some examples, aspects of the operations of 620 may be performed by a parity alerting component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for performing, as part of an ECC operation at the memory system, a plurality of first logical operations on a plurality of data bits to generate a plurality of ECC parity bits; performing, based at least in part on generating the plurality of ECC parity bits and as part of a data path parity operation at the memory system, a plurality of second logical operations on the plurality of ECC parity bits to generate an intermediate parity bit; performing, as part of the data path parity operation, a third logical operation between a single error correction bit and the intermediate parity bit to generate a data path parity bit; and outputting the data path parity bit to a host system coupled with the memory system.
Aspect 2: The method, apparatus, or non-transitory computer-readable medium of aspect 1, further including operations, features, circuitry, logic, means, or instructions, or any combination thereof for encoding, based at least in part on performing the third logical operation, the data path parity bit, where outputting the data path parity bit to the host system is based at least in part on encoding the data path parity bit.
Aspect 3: The method, apparatus, or non-transitory computer-readable medium of aspect 2, further including operations, features, circuitry, logic, means, or instructions, or any combination thereof for determining whether to encode the data path parity bit based at least in part on a value of a severity bit generated as part of the ECC operation on the plurality of data bits, the value of the severity bit indicating whether the plurality of data bits include an uncorrected error, where encoding the data path parity bit is based at least in part on the value of the severity bit indicating that the plurality of data bits do not include the uncorrected error.
Aspect 4: The method, apparatus, or non-transitory computer-readable medium of aspect 3, where a priority associated with the severity bit is greater than a priority associated with the data path parity bit and encoding the data path parity bit is further based at least in part on the priority associated with the severity bit being greater than the priority of the data path parity bit.
Aspect 5: The method, apparatus, or non-transitory computer-readable medium of any of aspects 3 through 4, where the uncorrected error includes one or more bits of the plurality of data bits being corrupted and uncorrectable.
Aspect 6: The method, apparatus, or non-transitory computer-readable medium of any of aspects 1 through 5, further including operations, features, circuitry, logic, means, or instructions, or any combination thereof for obtaining the plurality of data bits from a memory array of the memory system based at least in part on receiving a read request from the host system, where generating the plurality of ECC parity bits is based at least in part on obtaining the plurality of data bits from the memory array.
Aspect 7: The method, apparatus, or non-transitory computer-readable medium of any of aspects 1 through 6, further including operations, features, circuitry, logic, means, or instructions, or any combination thereof for performing a fourth logic operation between the plurality of ECC parity bits and a plurality of parity bits stored with the plurality of data bits to generate a plurality of syndrome bits and determining whether one or more bit-errors have occurred in the plurality of data bits based at least in part on an error code generated from the plurality of syndrome bits, where a value of the single error correction bit is based at least in part on determining whether the one or more bit-errors have occurred in the plurality of data bits.
Aspect 8: The method, apparatus, or non-transitory computer-readable medium of any of aspects 1 through 7, where the plurality of first logical operations include a plurality of first XOR operations, the plurality of second logical operations include a plurality of second XOR operations, and the third logical operation is an XOR operation.
Aspect 9: The method, apparatus, or non-transitory computer-readable medium of any of aspects 1 through 7, where the ECC parity bits are generated according to an odd-weighted matrix, and where the plurality of first logical operations are based on the odd-weighted matrix.

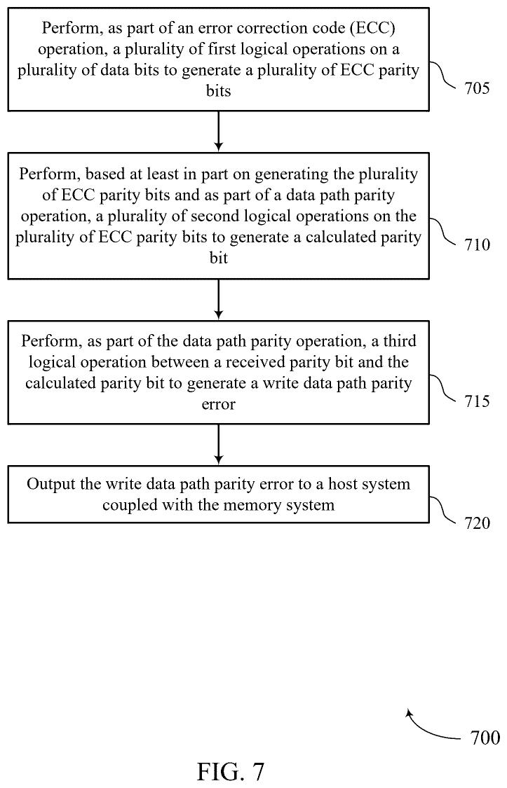

FIG. 7 shows a flowchart illustrating a method 700 that supports data path protection in memory systems in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include performing, as part of an ECC operation, a plurality of first logical operations on a plurality of data bits to generate a plurality of ECC parity bits. In some examples, aspects of the operations of 705 may be performed by a ECC engine component 525 as described with reference to FIG. 5.

At 710, the method may include performing, based at least in part on generating the plurality of ECC parity bits and as part of a data path parity operation, a plurality of second logical operations on the plurality of ECC parity bits to generate a calculated parity bit. In some examples, aspects of the operations of 710 may be performed by a DPP component 530 as described with reference to FIG. 5.

At 715, the method may include performing, as part of the data path parity operation, a third logical operation between a received parity bit and the calculated parity bit to generate a write data path parity error. In some examples, aspects of the operations of 715 may be performed by a parity comparison component 540 as described with reference to FIG. 5.

At 720, the method may include outputting the write data path parity error to a host system coupled with the memory system. In some examples, aspects of the operations of 720 may be performed by a parity alerting component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 10: A method, apparatus, or non-transitory computer-readable medium including operations, features, circuitry, logic, means, or instructions, or any combination thereof for performing, as part of an ECC operation, a plurality of first logical operations on a plurality of data bits to generate a plurality of ECC parity bits; performing, based at least in part on generating the plurality of ECC parity bits and as part of a data path parity operation, a plurality of second logical operations on the plurality of ECC parity bits to generate a calculated parity bit; performing, as part of the data path parity operation, a third logical operation between a received parity bit and the calculated parity bit to generate a write data path parity error; and outputting the write data path parity error to a host system coupled with the memory system.
Aspect 11: The method, apparatus, or non-transitory computer-readable medium of aspect 10, further including operations, features, circuitry, logic, means, or instructions, or any combination thereof for receiving, from the host system, a write request that includes a plurality of encoded bits and decoding the plurality of encoded bits to obtain the plurality of data bits based at least in part on receiving the write request, where generating the plurality of ECC parity bits is based at least in part on decoding the plurality of encoded bits.
Aspect 12: The method, apparatus, or non-transitory computer-readable medium of aspect 11, further including operations, features, circuitry, logic, means, or instructions, or any combination thereof for receiving, as part of the write request, a plurality of CRC bits associated with the plurality of encoded bits and detecting, based at least in part on decoding the plurality of encoded bits, whether one or more bit-errors are included in the plurality of data bits using the plurality of CRC bits, where performing the plurality of first logical operations is based at least in part on detecting whether the one or more bit-errors.
Aspect 13: The method, apparatus, or non-transitory computer-readable medium of any of aspects 11 through 12, where the received parity bit is obtained based at least in part on decoding the plurality of encoded bits and performing the third logical operation is based at least in part on decoding the plurality of encoded bits.
Aspect 14: The method, apparatus, or non-transitory computer-readable medium of any of aspects 10 through 13, where the write data path parity error indicates whether an odd quantity of uncorrected errors are present in the plurality of data bits.
Aspect 15: The method, apparatus, or non-transitory computer-readable medium of any of aspects 10 through 14, where the plurality of first logical operations include a plurality of first XOR operations, the plurality of second logical operations include a plurality of second XOR operations, and the third logical operation is an XOR operation.

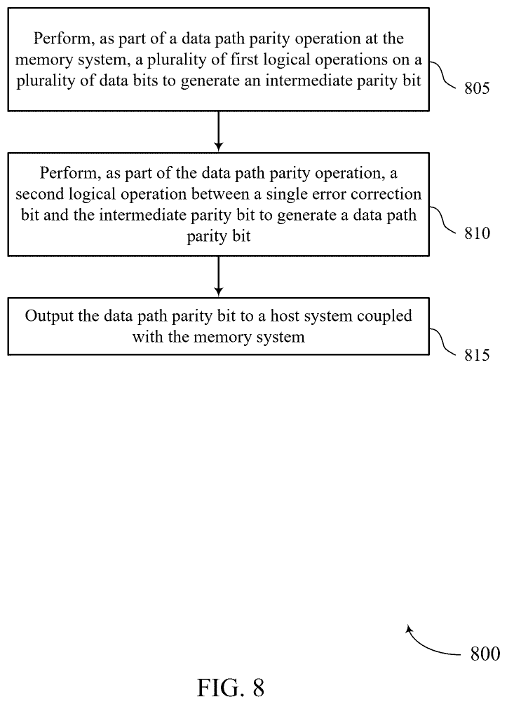

FIG. 8 shows a flowchart illustrating a method 800 that supports data path protection in memory systems in accordance with examples as disclosed herein. The operations of method 800 may be implemented by a memory system or its components as described herein. For example, the operations of method 800 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 805, the method may include performing, as part of a data path parity operation at the memory system, a plurality of first logical operations on a plurality of data bits to generate an intermediate parity bit. In some examples, aspects of the operations of 805 may be performed by a ECC engine component 525 as described with reference to FIG. 5.

At 810, the method may include performing, as part of the data path parity operation, a second logical operation between a single error correction bit and the intermediate parity bit to generate a data path parity bit. In some examples, aspects of the operations of 810 may be performed by a DPP component 530 as described with reference to FIG. 5.

At 815, the method may include outputting the data path parity bit to a host system coupled with the memory system. In some examples, aspects of the operations of 815 may be performed by a parity alerting component 535 as described with reference to FIG. 5.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 16: A method, apparatus, or non-transitory computer-readable medium including operations, features, circuitry, logic, means, or instructions, or any combination thereof for performing, as part of a data path parity operation at the memory system, a plurality of first logical operations on a plurality of data bits to generate an intermediate parity bit; performing, as part of the data path parity operation, a second logical operation between a single error correction bit and the intermediate parity bit to generate a data path parity bit; and outputting the data path parity bit to a host system coupled with the memory system.
Aspect 17: The method, apparatus, or non-transitory computer-readable medium of aspect 16, further including operations, features, circuitry, logic, means, or instructions, or any combination thereof for encoding, based at least in part on performing the second logical operation, the data path parity bit, where outputting the data path parity bit to the host system is based at least in part on encoding the data path parity bit.
Aspect 18: The method, apparatus, or non-transitory computer-readable medium of aspect 17, further including operations, features, circuitry, logic, means, or instructions, or any combination thereof for determining whether to encode the data path parity bit based at least in part on a value of a severity bit generated as part of an ECC operation on the plurality of data bits, the value of the severity bit indicating whether the plurality of data bits include an uncorrected error, where encoding the data path parity bit is based at least in part on the value of the severity bit indicating that the plurality of data bits do not include the uncorrected error.
Aspect 19: The method, apparatus, or non-transitory computer-readable medium of aspect 16, where a priority associated with the severity bit is greater than a priority associated with the data path parity bit and encoding the data path parity bit is further based at least in part on the priority associated with the severity bit being greater than the priority of the data path parity bit.
Aspect 20: The method, apparatus, or non-transitory computer-readable medium of any of aspects 16 through 17, where the uncorrected error includes one or more bits of the plurality of data bits being corrupted and uncorrectable.
Aspect 21: The method, apparatus, or non-transitory computer-readable medium of any of aspects 16through 20, further including operations, features, circuitry, logic, means, or instructions, or any combination thereof for obtaining the plurality of data bits from a memory array of the memory system based at least in part on receiving a read request from the host system, where performing the plurality of first logical operations is based at least in part on obtaining the plurality of data bits from the memory array.
Aspect 22: The method, apparatus, or non-transitory computer-readable medium of any of aspects 16 through 21, where the plurality of first logical operations include a plurality of first XOR operations, and the second logical operation is an XOR operation.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform, as part of an error correction code (ECC) operation at the memory system, a plurality of first logical operations on a plurality of data bits to generate a plurality of ECC parity bits;
perform, based at least in part on generating the plurality of ECC parity bits and as part of a data path parity operation at the memory system, a plurality of second logical operations on the plurality of ECC parity bits to generate an intermediate parity bit;
perform, as part of the data path parity operation, a third logical operation between a single error correction bit and the intermediate parity bit to generate a data path parity bit; and
output the data path parity bit to a host system coupled with the memory system.

2. The memory system of claim 1, wherein the processing circuitry is further configured to cause the memory system to:
encode, based at least in part on performing the third logical operation, the data path parity bit, wherein outputting the data path parity bit to the host system is based at least in part on encoding the data path parity bit.

3. The memory system of claim 2, wherein the processing circuitry is further configured to cause the memory system to:
determine whether to encode the data path parity bit based at least in part on a value of a severity bit generated as part of the ECC operation on the plurality of data bits, the value of the severity bit indicating whether the plurality of data bits include an uncorrected error, wherein encoding the data path parity bit is based at least in part on the value of the severity bit indicating that the plurality of data bits do not include the uncorrected error.

4. The memory system of claim 3, wherein:
a priority associated with the severity bit is greater than a priority associated with the data path parity bit, and
encoding the data path parity bit is further based at least in part on the priority associated with the severity bit being greater than the priority of the data path parity bit.

5. The memory system of claim 3, wherein the uncorrected error comprises one or more bits of the plurality of data bits being corrupted and uncorrectable.

6. The memory system of claim 1, wherein the processing circuitry is further configured to cause the memory system to:
obtain the plurality of data bits from a memory array of the memory system based at least in part on receiving a read request from the host system, wherein generating the plurality of ECC parity bits is based at least in part on obtaining the plurality of data bits from the memory array.

7. The memory system of claim 1, wherein the processing circuitry is further configured to cause the memory system to:
perform a fourth logic operation between the plurality of ECC parity bits and a plurality of parity bits stored with the plurality of data bits to generate a plurality of syndrome bits; and
determine whether one or more bit-errors have occurred in the plurality of data bits based at least in part on an error code generated from the plurality of syndrome bits, wherein a value of the single error correction bit is based at least in part on determining whether the one or more bit-errors have occurred in the plurality of data bits.

8. The memory system of claim 1, wherein the plurality of first logical operations comprise a plurality of first XOR operations, the plurality of second logical operations comprise a plurality of second XOR operations, and the third logical operation is an XOR operation.

9. The memory system of claim 1, wherein the plurality of ECC parity bits are generated according to an odd-weighted matrix, and wherein the plurality of first logical operations are based at least in part on the odd-weighted matrix.

10. A memory system, comprising:
one or more memory devices; and
processing circuitry coupled with the one or more memory devices and configured to cause the memory system to:
perform, as part of an error correction code (ECC) operation, a plurality of first logical operations on a plurality of data bits to generate a plurality of ECC parity bits;
perform, based at least in part on generating the plurality of ECC parity bits and as part of a data path parity operation, a plurality of second logical operations on the plurality of ECC parity bits to generate a calculated parity bit;
perform, as part of the data path parity operation, a third logical operation between a received parity bit and the calculated parity bit to generate a write data path parity error; and
output the write data path parity error to a host system coupled with the memory system.

11. The memory system of claim 10, wherein the processing circuitry is configured to cause the memory system to:
receive, from the host system, a write request that comprises a plurality of encoded bits; and
decode the plurality of encoded bits to obtain the plurality of data bits based at least in part on receiving the write request, wherein generating the plurality of ECC parity bits is based at least in part on decoding the plurality of encoded bits.

12. The memory system of claim 11, wherein the processing circuitry is configured to cause the memory system to:
receive, as part of the write request, a plurality of cyclic redundancy check (CRC) bits associated with the plurality of encoded bits; and
detect, based at least in part on decoding the plurality of encoded bits, whether one or more bit-errors are included in the plurality of data bits using the plurality of CRC bits, wherein performing the plurality of first logical operations is based at least in part on detecting whether the one or more bit-errors.

13. The memory system of claim 11, wherein:
the received parity bit is obtained based at least in part on decoding the plurality of encoded bits, and
performing the third logical operation is based at least in part on decoding the plurality of encoded bits.

14. The memory system of claim 10, wherein the write data path parity error indicates whether an odd quantity of uncorrected errors are present in the plurality of data bits.

15. The memory system of claim 10, wherein the plurality of first logical operations comprise a plurality of first XOR operations, the plurality of second logical operations comprise a plurality of second XOR operations, and the third logical operation is an XOR operation.

16. A memory system, comprising:
one or more memory devices; and
processing circuitry coupled with the one or more memory devices and configured to cause the memory system to:
perform, as part of a data path parity operation at the memory system, a plurality of first logical operations on a plurality of data bits to generate an intermediate parity bit;
perform, as part of the data path parity operation, a second logical operation between a single error correction bit and the intermediate parity bit to generate a data path parity bit; and
output the data path parity bit to a host system coupled with the memory system.

17. The memory system of claim 16, wherein the processing circuitry is configured to cause the memory system to:
encode, based at least in part on performing the second logical operation, the data path parity bit, wherein outputting the data path parity bit to the host system is based at least in part on encoding the data path parity bit.

18. The memory system of claim 17, wherein the processing circuitry is configured to cause the memory system to:
determine whether to encode the data path parity bit based at least in part on a value of a severity bit generated as part of an error correction code (ECC) operation on the plurality of data bits, the value of the severity bit indicating whether the plurality of data bits include an uncorrected error, wherein encoding the data path parity bit is based at least in part on the value of the severity bit indicating that the plurality of data bits do not include the uncorrected error.

19. The memory system of claim 18, wherein:
a priority associated with the severity bit is greater than a priority associated with the data path parity bit, and
encoding the data path parity bit is further based at least in part on the priority associated with the severity bit being greater than the priority of the data path parity bit.

20. The memory system of claim 18, wherein the uncorrected error comprises one or more bits of the plurality of data bits being corrupted and uncorrectable.

21. The memory system of claim 16, wherein the processing circuitry is configured to cause the memory system to:
obtain the plurality of data bits from a memory array of the memory system based at least in part on receiving a read request from the host system, wherein performing the plurality of first logical operations is based at least in part on obtaining the plurality of data bits from the memory array.

22. The memory system of claim 16, wherein the plurality of first logical operations comprise a plurality of first XOR operations, and the second logical operation is an XOR operation.
